(19) United States
(12) Patent Application Publication
(10) Pub. No.: US 2012/0285583 A1
(43) Pub. Date: Nov. 15, 2012

(54) CERIUM BASED PERMANENT MAGNET MATERIAL

(75) Inventors: Martin S. Meyer, Southfield, MI (US); Jan F. Herbst, Grosse Pointe Woods, MI (US); Frederick E. Pinkerton, Shelby Township, MI (US)

(73) Assignee: GM GLOBAL TECHNOLOGY OPERATIONS LLC, Detroit, MI (US)

(21) Appl. No.: 13/367,427

(22) Filed: Feb. 7, 2012

Related U.S. Application Data
(60) Provisional application No. 61/485,156, filed on May 12, 2011.

(51) Int. Cl. C21D 6/00; H01F 1/053; C22C 38/00

(52) U.S. Cl. 148/101; 420/83; 148/540

(57) ABSTRACT

Useful permanent magnet materials are formed by processing molten alloys of cerium, iron, and boron to form permanent magnet compositions with appreciable coercivity and remanence. For example, Ce_{16.7}Fe_{77.8}B_{5.6} has been produced with coercivity, H_{ci} of 6.18 kOe and remanence, Bᵣ of 4.92 kG. In one practice, streams of the molten alloy are rapidly quenched (e.g., by melt spinning) to form magnetically-soft melt-spun material which is suitably annealed to obtain permanent magnet properties. In another practice, the streams of molten alloy are quenched at a predetermined quench rate to directly obtain permanent magnet properties in the cerium-iron-boron material.

This application claims priority based on provisional application 61/485,156, titled “Cerium Based Permanent Magnet Material,” filed May 12, 2011 and which is incorporated herein by reference.

### TECHNICAL FIELD

This invention pertains to rare earth-iron-boron permanent magnets. More specifically, this invention pertains to cerium-iron-boron permanent magnets.

### BACKGROUND OF THE INVENTION

Melt-spun neodymium-iron-boron magnets were invented and commercialized by General Motors researchers in the early 1980s. The hard magnetic properties stem from the anisotropic crystal structure of the Nd₂Fe₁₄B compound, when melt quenched into a nanocrystalline microstructure together with a small amount of Nd-rich grain boundary phase. At that time the magnetic properties of melt-spun Ce—Fe—B were briefly explored, specifically at the same composition yielding optimum Nd—Fe—B material. However, owing to the superior magnetic properties of Nd—Fe—B, work was then directed to the neodymium-containing compositions. Rare earth-iron-boron magnets based on the ternary phase Nd₂Fe₁₄B remain today the best permanent magnets with energy products that can exceed 50 MGOe.

Renewed interest in Ce—Fe—B magnet materials has been stimulated by recent developments in rare earth supply and price. Nd is expensive, and furthermore Nd—Fe—B magnets are often modified with other rare earth additives such as Pr, Dy, Tb, or mixtures thereof, that enhance the magnetic properties. However, Pr, Dy, and Tb are also expensive, plus Dy and Tb constitute only a very small portion (˜2%) of a typical rare earth containing ore. Recently concerns have arisen about the future cost and availability of rare earths, particularly Nd, Pr, Dy, and Tb.

Samarium-cobalt permanent magnets have high energy product, but samarium is very expensive, and cobalt is more expensive than iron.

Ferrite magnets are inexpensive, but have limited magnetic properties.

Permanent magnets are used in electric motors, especially traction motors, and generators. Consequently there is an arising need for an alternative R—Fe—B magnet material based on the less expensive, more available rare earth Ce, while still retaining acceptable permanent magnet qualities.

### SUMMARY OF THE INVENTION

Early studies of melt-spun Ce—Fe—B ribbon materials produced annealed permanent magnet compositions with remanence values, Bᵣ, of only 3.4 kG, and coercivity values of H_{ci}=2.5 kOe. In accordance with practices of this invention, magnetic properties of compositions of the Ce—Fe—B system have been improved to achieve Bᵣ of about 5.3 kG and H_{ci} of up to 7.1 kOe (but not necessarily both values in a specific Ce—Fe—B composition). Many melt-spun and annealed Ce—Fe—B compositions have been produced in selected molar proportions yielding permanent magnets with coercivity values (H_{ci}, in kOe) and remanence values (Bᵣ, in kG) where the sums of the numerical values of H_{ci} and Bᵣ are equal to 8 or greater. And in many rapidly-solidified and annealed compositions the sums of the H_{ci} and Bᵣ values exceed 9.

In many instances the data presented in this specification are refined with respect to the data presented in the above-identified provisional application. Also, the compositions of the magnetic materials are presented in this specification as CeₐFe_{b}B_{c}, where a, b, and c are molar values totaling 100. This format is preferred for easy recognition. Compositional formulas were presented in the provisional application in a slightly different format, but the formulas in the provisional specification are readily converted to the compositional format used in this specification.

In our provisional application, it was disclosed that compositions of CeₐFe_{b}B_{c}, where a, b, and c are mole fractions totaling 1 and having values 0.10<a<0.33, 0.44<b<0.82, and 0<c<0.44, were prepared having permanent magnet properties that are higher than previously obtained with Ce—Fe—B compositions. As the data has been refined, it has been determined that CeₐFe_{b}B_{c} compositions are preferred where 13.0≦a≦26.8, 70.0≦b≦81.5, 3.2≦c≦12.0, and the values of a, b, and c total 100. Further, such compositions are selected so that they may be processed to produce coercivity and remanence values as specified above in this specification. Magnetic data for representative preferred Ce—Fe—B permanent magnet compositions are found in Tables I and II of this specification.

These materials are initially prepared as a melt, protected under a non-oxidizing atmosphere. In one practice of the invention the melt is quenched or otherwise rapidly solidified (e.g., by melt spinning) to form particles of soft magnet precursor materials. Particles of the soft magnet material are then annealed to form permanent magnet powder, which may be bonded or sintered into permanent magnet shapes and magnetized for many applications. The annealing temperature typically varies among individual cerium-iron-boron compositions, and a preferred annealing temperature for best permanent magnet properties may be found for each three-component composition.

Melt spun and carefully annealed Ce_{16.7}Fe_{77.8}B_{5.6} has been produced with an intrinsic coercivity, H_{ci} of 6.18 kOe and remanence, Bᵣ of 4.92 kG. Similarly, Ce_{14.3}Fe_{78.6}B_{7.1} has been produced with coercivity, H_{ci} of 5.43 kOe and remanence, Bᵣ of 5.33 kG. Other rapidly solidified and annealed Ce—Fe—B compositions that have good permanent magnet properties include Ce_{15.4}Fe_{76.9}B_{7.7}, Ce_{17.9}Fe_{77.9}B_{4.2}, Ce_{22.8}Fe_{71.1}B_{6.1}, Ce_{14.4}Fe_{74.9}B_{10.7}, Ce_{18.2}Fe_{72.7}B_{9.1}, Ce_{21.1}Fe_{73.7}B_{5.3}, Ce_{13.3}Fe_{80.0}B_{6.7}, Ce_{18.5}Fe_{70.0}B_{11.5}, and Ce_{23.1}Fe_{73.5}B_{3.4}. Magnetic properties for these compositions are summarized in Table I presented below in this specification. It is seen that the highest values of both H_{ci} and Bᵣ are not found simultaneously in any single Ce—Fe—B composition.

In another practice of the invention, the molten alloy is quenched at a predetermined quench rate, such as at a predetermined melt-spinning quench wheel speed, to directly produce CeₐFe_{b}B_{c} permanent magnet material. In this direct quench method the material usually does not require an anneal to produce its permanent magnet properties. For example, direct quenched Ce_{16.7}Fe_{77.8}B_{5.6} has been produced with an intrinsic coercivity, H_{ci} of 5.32 kOe and remanence, Bᵣ of 5.19 kG. The direct quench particles may, for example, be ball milled to a desired particle size and resin bonded or hot compacted into a magnet body of desired shape.

Other objects and advantages of the invention will be apparent from a description of illustrative embodiments which follows in this specification.

### BRIEF DESCRIPTION OF THE DRAWINGS

FIG. 1 is a section of the Ce—Fe—B phase diagram indicating starting compositions investigated in studies presented in this specification. The labels correspond to the entries in Table I, and the small squares are shaded on a gray scale for (Bᵣ+H_{ci}) ranging from black (smallest values) to white (largest values).

FIG. 2 is a graph of values for Bᵣ, H_{ci}, and (BH)ₘₐₓ after heat treatment for 5 minutes at various temperatures for the Ce_{16.7}Fe_{77.8}B_{5.6} sample (Sample A) of Table I.

FIG. 3 presents Cu Kα x-ray diffraction diagrams for (a) as-spun and (b) heat treated Ce_{16.7}Fe_{77.8}B_{5.6}. The unlabeled peaks are Ce₂Fe₁₄B, the primary constituent in (b).

FIG. 4 is the room temperature demagnetization curve for heat treated Ce_{16.7}Fe_{77.8}B_{5.6} (Sample A in Table I).

FIG. 5 is a graph of the varying magnetic properties (Y-axis) of five melts of Ce_{16.7}Fe_{77.8}B_{5.6} composition quenched on a chromium-plated copper wheel (25 cm diameter) spinning at wheel surface speeds (X-axis) of 16, 19, 22, 25, and 28 m/s. The values H_{ci} in kOe are represented by diamond shaped data points, the values of Bᵣ with square data points, and the values of (BH)ₘₐₓ with filled circles. The dashed lines crossing the graph from the Y-axis (with the same data points indicated) present the corresponding magnetic properties of an over quenched and optimally annealed Ce_{16.7}Fe_{77.8}B_{5.6} (Sample A in Table I).

### DESCRIPTION OF PREFERRED EMBODIMENTS

While the intrinsic magnetic properties of Ce₂Fe₁₄B (saturation magnetization 4πMₛ=11.7 kG and anisotropy field Hₐ=26 kOe at 295K, Curie temperature T_{c}=424K) are inferior to those of Nd₂Fe₁₄B (4πMₛ=16 kG, Hₐ=73 kOe, T_{c}=585K), they are nevertheless sufficient to offer the potential for producing Ce—Fe—B magnets having hard magnet characteristics intermediate between those of ferrites and Nd—Fe—B.

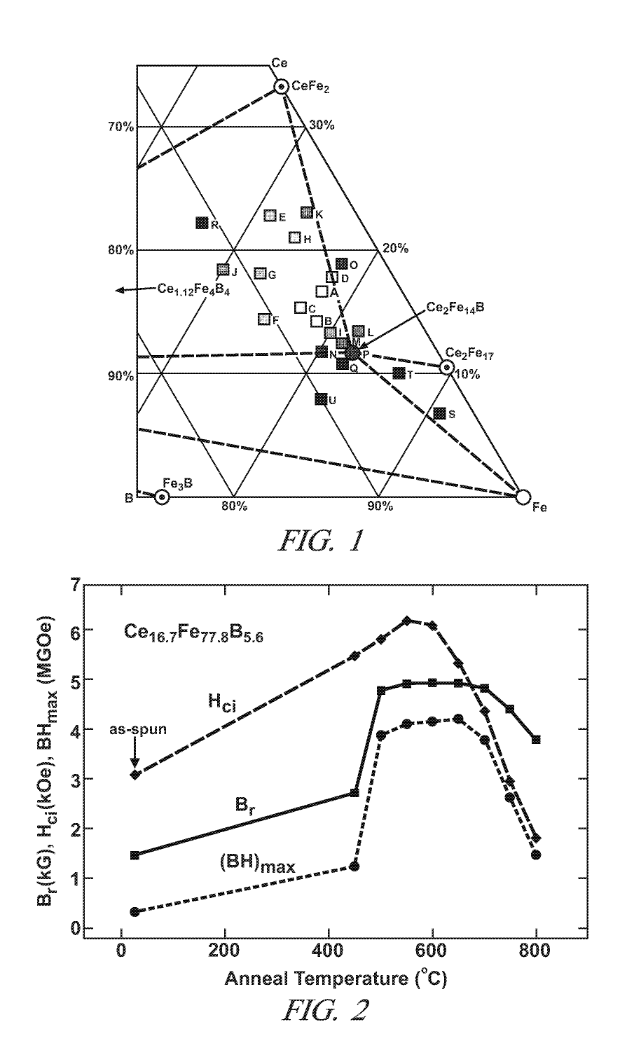

Since the Ce—Fe—B phase diagram is distinct from that of Nd—Fe—B in several respects, featuring in particular the compound CeFe₂ having no Nd analog under normal conditions, it was anticipated that the Ce—Fe—B composition yielding the most favorable hard magnet properties via rapid solidification might well differ from the optimum composition for Nd—Fe—B. Accordingly, a range of compositions was explored that is indicated by the squares in the section of the Ce—Fe—B phase diagram near the Fe vertex shown in FIG. 1 and detailed in Table I.

Ingots of Ce—Fe—B of various compositions were made by induction melting the elements. Ribbons of Ce—Fe—B were melt-spun by induction melting pieces of ingot in a quartz crucible under an argon inert gas atmosphere and ejecting the molten alloy through a 0.6 mm diameter orifice onto the circumferential surface of a chromium-plated copper wheel (25 cm diameter) spinning at a wheel surface speed, vₛ, of 35 m/s. The molten stream is rapidly solidified as it hits the spinning quench wheel and ribbon fragments are thrown from the wheel and collected while still in the protective argon atmosphere. This wheel speed, vₛ, corresponds to a quench rate large enough to yield “overquenched” as-spun ribbon fragments that are mostly amorphous or nanocrystalline. A portion of the collected ribbon product was ground to a coarse powder in a SPEX 8000 High Energy Ball Mill (HEBM) by milling for 2 minutes in an argon atmosphere. X-ray diffraction (XRD) of the as-quenched powder showed a superposition of peaks from nanocrystalline material together with very broad peaks of an amorphous powder diffraction pattern.

Powdered ribbons were heat treated using a Perkin-Elmer, System 7 thermogravimetric analyzer (TGA). The ribbons were heated at 100° C./min under flowing argon to a target temperature, held at temperature for 5 min, and then cooled at 100° C./min back to room temperature. No significant weight changes occurred during heat treatment. The target temperature was varied between 450° C. and 800° C. to determine the temperature, Tₐ, at which the remanence Bᵣ, intrinsic coercivity H_{ci} and energy product (BHₘₐₓ) are maximized. Requiring only that the quench rate (i.e., vₛ to a first approximation) exceed a minimum value to produce largely amorphous material, this procedure is an alternative to identifying the best vₛ for each composition; it was originally established many years ago for melt-spun Nd—Fe—B. Identifying a best vₛ for molten CeₐFe_{b}B_{c} alloys is demonstrated below in this specification.

Magnetic properties of the heat treated ribbons were measured on a PAR model 155 vibrating sample magnetometer (VSM). Crushed powder was loaded into a KEL-F sample holder, and then fully magnetized by a pulsed magnetic field. Demagnetization curves were measured to a maximum reverse field of 18.9 kOe.

The variation in magnetic properties with composition is summarized in the following Table I.

TABLE I

| | | Tₐ | Bᵣ | H_{ci} | (BH)ₘₐₓ | |
|---|---|---|---|---|---|---|
| Composition | | (° C.) | (kG) | (kOe) | (MGOe) | Bᵣ + H_{ci} |
| Ce_{16.7}Fe_{77.8}B_{5.6} | (A) | 550 | 4.92 | 6.18 | 4.12 | 11.10 |
| Ce_{14.3}Fe_{78.6}B_{7.1} | (B) | 500 | 5.33 | 5.43 | 4.59 | 10.76 |
| Ce_{15.4}Fe_{76.9}B_{7.7} | (C) | 600 | 4.68 | 5.77 | 3.43 | 10.46 |
| Ce_{17.9}Fe_{77.9}B_{4.2} | (D) | 600 | 4.59 | 5.60 | 3.30 | 10.19 |
| Ce_{22.8}Fe_{71.1}B_{6.1} | (E) | 600 | 2.87 | 7.09 | 1.39 | 9.96 |
| Ce_{14.4}Fe_{74.9}B_{10.7} | (F) | 600 | 4.99 | 4.67 | 3.64 | 9.66 |
| Ce_{18.2}Fe_{72.7}B_{9.1} | (G) | 500 | 3.15 | 6.42 | 1.64 | 9.57 |
| Ce_{21.1}Fe_{73.7}B_{5.3} | (H) | 600 | 3.19 | 6.27 | 1.52 | 9.47 |
| Ce_{13.3}Fe_{80.0}B_{6.7} | (I) | 600 | 5.21 | 3.19 | 2.79 | 8.40 |
| Ce_{18.5}Fe_{70.0}B_{11.5} | (J) | 600 | 3.46 | 4.87 | 1.69 | 8.34 |
| Ce_{23.1}Fe_{73.5}B_{3.4} | (K) | 600 | 2.87 | 5.40 | 1.10 | 8.26 |
| Ce_{13.5}Fe_{81.9}B_{4.7} | (L) | 650 | 4.78 | 3.13 | 2.52 | 7.91 |
| Ce_{12.5}Fe_{81.3}B_{6.3} | (M) | 600 | 5.12 | 2.60 | 2.36 | 7.72 |
| Ce_{11.8}Fe_{80.2}B_{8.0} | (N) | 600 | 3.88 | 2.84 | 1.64 | 6.72 |
| Ce_{18.9}Fe_{78.0}B_{3.1} | (O) | 700 | 2.63 | 3.95 | 1.06 | 6.57 |
| Ce_{11.8}Fe_{82.4}B_{5.9} | (P) | 700 | 4.52 | 1.65 | 1.46 | 6.17 |
| Ce_{10.9}Fe_{82.1}B_{7.0} | (Q) | 700 | 4.17 | 1.39 | 1.18 | 5.56 |
| Ce_{22.2}Fe_{66.7}B_{11.1} | (R) | 800 | 2.04 | 3.31 | 0.66 | 5.35 |
| Ce_{6.8}Fe_{90.9}B_{2.3} | (S) | 700 | 3.23 | 0.65 | 0.45 | 3.88 |
| Ce_{10.1}Fe_{86.4}B_{3.5} | (T) | 700 | 2.59 | 0.83 | 0.41 | 3.42 |
| Ce_{8.0}Fe_{82.1}B_{10.10} | (U) | 700 | 2.30 | 0.60 | 0.30 | 2.90 |

FIG. 2 illustrates the development of Bᵣ, H_{ci}, and (BH)ₘₐₓ with anneal temperature for the Ce_{16.7}Fe_{77.8}B_{5.6} composition of Table I. All three quantities do not grow appreciably from their as-spun values until ˜450° C., at which point large scale crystallization begins as x-ray diffraction (XRD) clearly shows. FIG. 2 is qualitatively representative of all the results inasmuch as the properties are collectively maximal at either a single anneal temperature Tₐ or, in a few cases, over a narrow temperature interval. While Tₐ=600° C. for half of the samples in Table I, the variation of optimal Tₐ with composition is considerable.

It is also evident from Table I that the maximum values of the three magnetic properties do not occur for a unique composition: among the formulations we prepared, Bᵣ and (BH)ₘₐₓ are largest for Ce_{14.3}Fe_{78.6}B_{7.1} (composition B), while H_{ci} peaks for the substantially Ce-richer composition Ce_{22.8}Fe_{71.1}B_{6.1} (E). To organize the results in a way that emphasizes remanence and coercivity equally, certainly justifiable from a technological perspective, we use their sum as a convenient and practical, although arbitrary, figure of merit. The entries in Table I are given in order of decreasing (Bᵣ+H_{ci}), and the squares in FIG. 1 are shaded on a gray scale for that quantity varying from filled/black (smallest) to unfilled/white (largest). On this basis Ce_{16.7}Fe_{77.8}B_{5.6} (A) is the single composition yielding the best overall performance while the squares A, B, and C in FIG. 1 demarcate the region of most favorable compositions. As is the case for Nd—Fe—B, the stoichiometric Ce₂Fe₁₄B composition [Ce_{11.8}Fe_{82.4}B_{5.9} (P) in Table I] leads to inferior Bᵣ and markedly reduced H_{ci} when compared with the best results; this is likely a consequence of insufficient intergranular material in the heat treated ribbons to inhibit domain wall motion.

By means of time-temperature observations of thermal arrest during the cooling of several melted ingots (A, D, G, O, T in Table I) roughly spanning our composition region, we determined that the Ce—Fe—B liquidus is in the narrow 1041° C.-1056° C. interval (substantially smaller than the ˜90° C. excursion of melting points for the same Ce/Fe ratio range in the Ce—Fe phase diagram, illustrating one profound effect of boron). Since the melt temperature in almost all of our spins (A-F, H-K, M-P, R in Table I) was 1300° C., the difference between it and the liquidus was essentially independent of stoichiometry, hence it can be inferred that composition rather than quenching regimen is the primary factor controlling the magnetics.

We emphasize that the Ce_{16.7}Fe_{77.8}B_{5.6} (A) composition yields properties superior to those of Ce_{13.5}Fe_{81.9}B_{4.7} (L), the Ce—Fe—B analog of the optimum Nd—Fe—B composition. In FIG. 1, square A is located in the triangle formed by CeFe₂ and the two ternaries Ce₂Fe₁₄B and Ce_{1.12}Fe₄B₄ while L resides on the other side of the CeFe₂—Ce₂Fe₁₄B tie line in the CeFe₂—Ce₂Fe₁₄B—Ce₂Fe₁₇ triangle having two Ce—Fe binary vertices. R₂Fe₁₇ (R≡ rare earth) is the only binary R—Fe compound common to the Ce—Fe—B and Nd—Fe—B phase diagrams, each of which contains two R—Fe phases: the second is CeFe₂ in the former and Nd₅Fe₁₇ in the latter. Nd_{13.5}Fe_{81.9}B_{4.7} resides within the triangle formed by Nd₂Fe₁₇, Nd₂Fe₁₄B, and Nd₅Fe₁₇ instead of RFe₂. With the caveat that inferences based on the equilibrium phase structure may not necessarily apply to rapidly quenched materials, the presence of Nd₅Fe₁₇ (Nd_{22.7}Fe_{77.3}), substantially richer in Fe than RFe₂ (R_{33.3}Fe_{66.7}), is evidently linked to the fact that the optimum Nd—Fe—B formulation R_{13.5}Fe_{81.9}B_{4.7} is also Fe richer than the optimum Ce—Fe—B composition R_{16.7}Fe_{77.8}B_{5.6} and thus in closer proximity to R₂Fe₁₄B. Moreover, in optimized Nd_{13.5}Fe_{81.9}B_{4.7} the only secondary component is an intergranular Nd—Fe binary alloy, in qualitative agreement with its position in the Nd—Fe—B phase diagram.

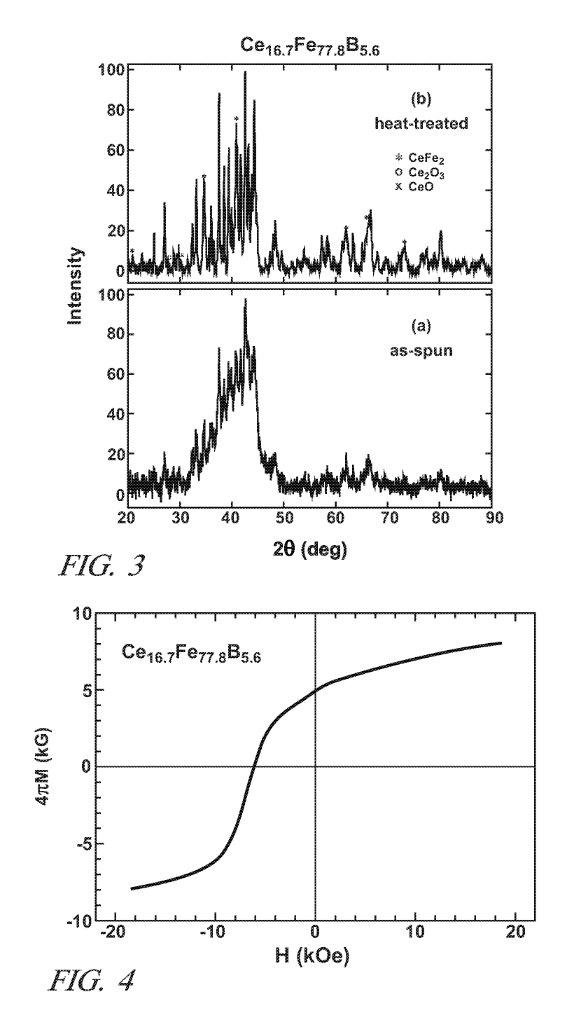

XRD patterns for Ce_{16.7}Fe_{77.8}B_{5.6} (A) are displayed in FIG. 3. The as-spun material [FIG. 3 (a)] is comprised of a substantial amorphous component as well as nanocrystalline Ce₂Fe₁₄B and CeFe₂. On heat treatment above 450° C. full crystallinity develops [FIG. 3 (b)]; the principal lines are those of Ce₂Fe₁₄B with clear evidence for an appreciable CeFe₂ fraction and minor contamination by Ce₂O₃ and CeO. Given the location of sample A in FIG. 1 we can determine the phase fractions in equilibrium:

Ce_{16.7}Fe_{77.8}B_{5.6}=0.746 Ce_{11.8}Fe_{82.4}B_{5.9}+0.227 Ce_{33.3}Fe_{66.7}+0.027 Ce_{12.3}Fe_{43.9}B_{43.95}

where Ce_{11.8}Fe_{82.4}B_{5.9}, Ce_{33.3}Fe_{66.75} and Ce_{12.3}Fe_{43.9}B_{43.9} respectively represent the phases Ce₂Fe₁₄B, CeFe₂, and Ce_{1.12}Fe₄B₄ normalized to 100 atoms per phase to be consistent with the notation for the starting composition, Ce_{16.7}Fe_{77.8}B_{5.6} on the left side. The relatively small coefficient of Ce_{12.3}Fe_{43.9}B_{43.9} may be responsible for its lack of an x-ray signature in FIG. 3 (b); it is also possible that the phase is amorphous even after heat treatment and cannot be distinguished from background or that the non-equilibrium processing suppresses its formation.

A multi-component Rietveld analysis of FIG. 3 (b) yields Ce₂Fe₁₄B and CeFe₂ mass fractions of ˜87% and ˜12%, respectively, with the ˜1% balance a mixture of Ce₂O₃ and CeO. Using densities ρ(Ce₂Fe₁₄B)=7.7 g/cm³, ρ(CeFe₂)=8.6 g/cm³, and the average of ρ(Ce₂O₃)=6.6 g/cm³ and ρ(CeO)=7.9 g/cm³ for the oxides leads to corresponding volume fractions of ˜88%, ˜11%, and ˜1%.

Ce₂Fe₁₄B is the only species present that is magnetic at room temperature, thus the remanence of an isotropic magnet comprising 88 vol % uniaxial Ce₂Fe₁₄B having 4πMₛ=11.7 kG can be estimated as Bᵣ˜0.88×0.5×11.7 kG=5.15 kG, in good agreement with our measured value of 4.92 kG. Analysis of the line widths affords estimates of ˜60 nm and ˜20 nm for average Ce₂Fe₁₄B and CeFe₂ grain sizes, respectively. We note that Bᵣ=5.33 kG for the Ce_{14.3}Fe_{78.6}B_{7.1}(B) sample in Table I implies a Ce₂Fe₁₄B volume fraction larger than that for sample A, but at the expense of coercivity. In optimized Nd—Fe—B the Nd₂Fe₁₄B volume fraction is ˜95% and the average grain size is ˜30 nm. Moreover, the only secondary component is an intergranular Nd—Fe binary alloy. The differences in overall composition and secondary phase occurrence between optimized melt-spun Ce—Fe—B and Nd—Fe—B are consequences of the contrast between the Ce—Fe—B and Nd—Fe—B phase diagrams, as discussed in paragraph [0027]. In turn, that contrast is due at least in part to the fact that the Nd ion is trivalent while the Ce ion is tetravalent when combined with Fe and B; the distinct bond character that results from the different number of valence electrons affects the stoichiometry and number of the compounds that form.

FIG. 4 shows the demagnetization curve for the Ce_{16.7}Fe_{77.8}B_{5.6} (A) sample measured in a ±19 kOe applied field range after an initial 40 kOe magnetizing pulse. The curve is typical of a random magnet. The small kink near 1 kOe reverse field arises from a minor fraction of large Ce₂Fe₁₄B grains having low coercivity.

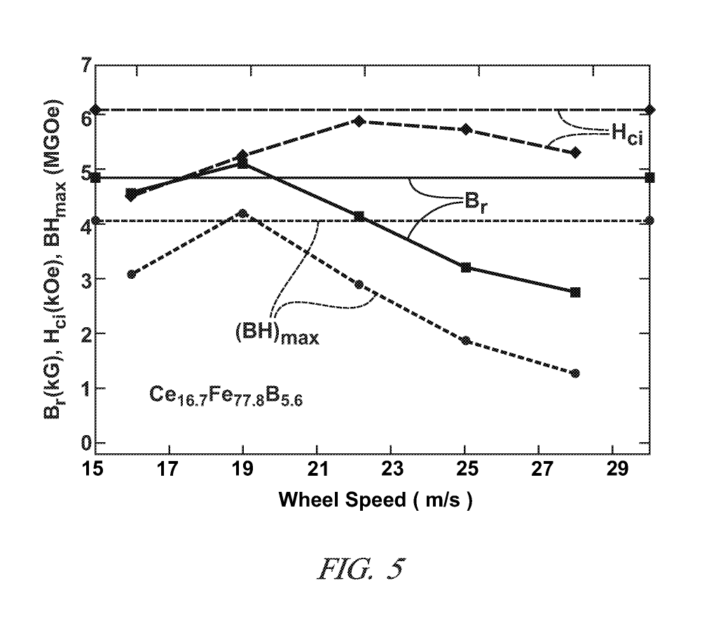

In the practices of the invention described above in this specification the melt of the selected CeₐFe_{b}B_{c} composition was over-quenched and then optimally annealed to obtain good permanent magnet properties. In another practice of the invention portions of the CeₐFe_{b}B_{c} are melt-spun using varying quench wheel speeds to determine a quench rate that directly yields a melt-spun product with permanent magnet properties. For example, a melt of the above specified Ce_{16.7}Fe_{77.8}B_{5.6} (A) composition was prepared in a quartz crucible and portions of the molten alloy were ejected through a 0.6 mm diameter onto the circumferential surface of the chromium-plated copper wheel (25 cm diameter). Fragments of melt-spun Ce_{16.7}Fe_{77.8}B_{5.6} composition were obtained using wheel surface speeds of 16 m/s, 19 m/s, 22 m/s, 25 m/s, and 28 m/s. The melt-spun fragments were ball milled as-is (no anneal) and their magnetic properties determined. This data is presented in the following Table II and graphically in FIG. 5.

TABLE II

| Wheel | | | | |
|---|---|---|---|---|
| speed | Bᵣ | H_{ci} | (BH)ₘₐₓ | |
| (m/s) | (kG) | (kOe) | (MGOe) | H_{ci} + Bᵣ |
| 16 | 4.63 | 4.53 | 3.14 | 9.16 |
| 19 | 5.19 | 5.32 | 4.27 | 10.52 |
| 22 | 4.25 | 5.96 | 2.99 | 10.20 |
| 25 | 3.28 | 5.80 | 1.90 | 9.08 |
| 28 | 2.82 | 5.37 | 1.30 | 8.19 |

FIG. 5 is a graphical presentation of the data in Table II. The varying magnetic properties of the five melts of Ce_{16.7}Fe_{77.8}B_{5.6} composition are presented on the Y-axis with the quench wheel speed presented on the X-axis. Values H_{ci} in kOe are represented by diamond shaped data points, the values of Bᵣ with square data points, and the values of (BH)ₘₐₓ with filled circles. The dashed lines crossing the graph from the Y-axis (using the same symbols for the data) present the corresponding magnetic properties of an over quenched and optimally annealed Ce_{16.7}Fe_{77.8}B_{5.6} (Sample A in Table I).

In the examples described above in this specification the chromium-coated copper quench wheel was relatively massive compared to the volumes of liquid cerium-iron-boron alloys being quenched. It was initially at room temperature and it did not require cooling. However, in the melt spinning and quenching of larger volumes of such molten alloys it may be necessary to provide for cooling or other temperature control of the quench wheel.

Thus, we have identified the region of the Ce—Fe—B phase diagram from which materials primarily comprised of Ce₂Fe₁₄B and having optimum hard magnet properties can be synthesized by melt spinning. As is generally the case for melt-spun magnets, the composition can be varied to improve Bᵣ and (BH)ₘₐₓ at the sacrifice of H_{ci}, and vice versa. Bᵣ and H_{ci} values that are ˜50% of 4πMₛ (the upper limit for an isotropic uniaxial magnet) and ˜27% of Hₐ, respectively, have been achieved in heat treated ribbons. By these metrics the results are quite comparable to those well established for Nd—Fe—B.

Certain practices of the invention have been presented for the purpose of illustration and not for the purpose of limiting the scope of the invention.

1. A permanent magnet composition consisting essentially of the elements cerium, iron, and boron in a crystalline product and in molar proportions providing values of intrinsic coercivity, H_{ci} in kOe, and remanence, Bᵣ in kG, where the numerical sum of H_{ci} and Bᵣ is 8 or greater.

2. A permanent magnet composition as recited in claim 1 in which the numerical sum of H_{ci} and Bᵣ is 9 or greater.

3. A permanent magnet composition as recited in claim 1 in which the permanent magnet composition is a composition selected from the group consisting of Ce_{16.7}Fe_{77.8}B_{5.6}, Ce_{14.3}Fe_{78.6}B_{7.1}, Ce_{15.4}Fe_{76.9}B_{7.7}, Ce_{17.9}Fe_{77.9}B_{4.2}, Ce_{22.8}Fe_{71.1}B_{6.1}, Ce_{14.4}Fe_{74.9}B_{10.7}, Ce_{18.2}Fe_{72.7}B_{9.1}, Ce_{21.1}Fe_{73.7}B_{5.3}, Ce_{13.3}Fe_{80.0}B_{6.7}, Ce_{18.5}Fe_{70.0}B_{11.5}, and Ce_{23.1}Fe_{73.5}B_{3.4}.

4. A permanent magnet composition as recited in claim 1 consisting essentially of the elements cerium, iron, and boron, CeₐFe_{b}B_{c}, in molar proportions where 13.0≦a≦26.8, 70.0≦b≦81.5, 3.2≦c≦12.0, and the values of a, b, and c total 100.

5. A permanent magnet composition as recited in claim 4 in which the permanent magnet material is a crystalline product comprised principally of the compound Ce₂Fe₁₄B.

6. A permanent magnet composition as recited in claim 4 in which the permanent magnet material is a crystalline product comprised principally of the compound Ce₂Fe₁₄B with smaller amounts of CeFe₂ and Ce_{1.12}Fe₄B₄.

7. A permanent magnet composition as recited in claim 5 in which the numerical sum of H_{ci} and Bᵣ is 9 or greater.

8. A permanent magnet composition as recited in claim 4 in which the permanent magnet composition is selected from the group consisting of Ce_{16.7}Fe_{77.8}B_{5.6}, Ce_{14.3}Fe_{78.6}B_{7.1}, Ce_{15.4}Fe_{76.9}B_{7.7}, Ce_{17.9}Fe_{77.9}B_{4.2}, Ce_{22.8}Fe_{71.1}B_{6.1}, Ce_{14.4}Fe_{74.9}B_{10.7}, Ce_{18.2}Fe_{72.7}B_{9.1}, Ce_{21.1}Fe_{73.7}B_{5.3}, Ce_{13.3}Fe_{80.0}B_{6.7}, Ce_{18.5}Fe_{70.0}B_{11.5}, and Ce_{23.1}Fe_{73.5}B_{3.4}.

9. A method of making a permanent magnet composition comprising:
preparing a melt of an alloy consisting essentially of the elements cerium, iron, and boron, the melt being under a non-oxidizing atmosphere; and processing the melt by (a) cooling the molten alloy at a predetermined rate to form particles of a crystalline material having permanent magnet properties or by (b) rapidly cooling the molten alloy to form amorphous or nanocrystalline particles of the cerium-iron-boron composition from the melt, some particles having properties of a soft magnetic material and annealing the soft magnetic material at a temperature above about 450° C. for a time to form a crystalline material having permanent magnet properties;
the (a) or (b) preparation producing a crystalline product comprised principally of the compound Ce₂Fe₁₄B, the crystalline material having values of intrinsic coercivity, H_{ci} in kOe, and remanence, Bᵣ in kG, where the numerical sum of H_{ci} and Bᵣ is 8 or greater.

10. A method as recited in claim 9 in which the numerical sum of H_{ci} and Bᵣ is 9 or greater.

11. A method as recited in claim 9 in which the permanent magnet composition produced is selected from the group consisting of Ce_{16.7}Fe_{77.8}B_{5.6}, Ce_{14.3}Fe_{78.6}B_{7.1}, Ce_{15.4}Fe_{76.9}B_{7.7}, Ce_{17.9}Fe_{77.9}B_{4.2}, Ce_{22.8}Fe_{71.1}B_{6.1}, Ce_{14.4}Fe_{74.9}B_{10.7}, Ce_{18.2}Fe_{72.7}B_{9.1}, Ce_{21.1}Fe_{73.7}B_{5.3}, Ce_{13.3}Fe_{80.0}B_{6.7}, Ce_{18.5}Fe_{70.0}B_{11.5}, and Ce_{23.1}Fe_{73.5}B_{3.4}.

12. A method of making a permanent magnet composition as recited in claim 9 comprising:
preparing a melt consisting essentially of the elements cerium, iron, and boron, the melt being under a non-oxidizing atmosphere;
forming rapidly solidified, amorphous or nanocrystalline particles of the cerium-iron-boron composition from the melt, some particles having properties of a soft magnetic material;
annealing the soft magnetic material at a temperature above about 450° C. for a time to form a crystalline material having permanent magnet properties, comprised principally of the compound Ce₂Fe₁₄B, and the temperature and duration of the anneal providing the crystalline material with values of intrinsic coercivity, H_{ci} in kOe, and remanence, Bᵣ in kG, where the numerical sum of H_{ci} and Bᵣ is 8 or greater.

13. A method as recited in claim 12 in which the numerical sum of H_{ci} and Bᵣ is 9 or greater.

14. A method as recited in claim 12 in which the permanent magnet composition produced is selected from the group consisting of Ce_{16.7}Fe_{77.8}B_{5.6}, Ce_{14.3}Fe_{78.6}B_{7.1}, Ce_{15.4}Fe_{76.9}B_{7.7}, Ce_{17.9}Fe_{77.9}B_{4.2}, Ce_{22.8}Fe_{71.1}B_{6.1}, Ce_{14.4}Fe_{74.9}B_{10.7}, Ce_{18.2}Fe_{72.7}B_{9.1}, Ce_{21.1}Fe_{73.7}B_{5.3}, Ce_{13.3}Fe_{80.0}B_{6.7}, Ce_{18.5}Fe_{70.0}B_{11.5}, and Ce_{23.1}Fe_{73.5}B_{3.4}.

15. A method of making a permanent magnet composition as recited in claim 9 comprising:
preparing a melt of an alloy consisting essentially of the elements cerium, iron, and boron, the melt being under a non-oxidizing atmosphere; and cooling the molten alloy at a predetermined rate to form particles of a crystalline material having permanent magnet properties, the crystalline product being comprised principally of the compound Ce₂Fe₁₄B, the crystalline material having values of intrinsic coercivity, H_{ci} in kOe, and remanence, Bᵣ in kG, where the numerical sum of H_{ci} and Bᵣ is 8 or greater.

16. A method as recited in claim 15 in which the numerical sum of H_{ci} and Bᵣ is 9 or greater.

17. A method as recited in claim 15 in which the permanent magnet composition produced is selected from the group consisting of Ce_{16.7}Fe_{77.8}B_{5.6}, Ce_{14.3}Fe_{78.6}B_{7.1}, Ce_{15.4}Fe_{76.9}B_{7.7}, Ce_{17.9}Fe_{77.9}B_{4.2}, Ce_{22.8}Fe_{71.1}B_{6.1}, Ce_{14.4}Fe_{74.9}B_{10.7}, Ce_{18.2}Fe_{72.7}B_{9.1}, Ce_{21.1}Fe_{73.7}B_{5.3}, Ce_{13.3}Fe_{80.0}B_{6.7}, Ce_{18.5}Fe_{70.0}B_{11.5}, and Ce_{23.1}Fe_{73.5}B_{3.4}.

18. A method of making a permanent magnet composition comprising:
preparing a melt of an alloy consisting essentially of the elements cerium, iron, and boron, CeₐFe_{b}B_{c}, in molar proportions where 13.0≦a≦26.8, 70.0≦b≦81.5, 3.2≦c≦12.0, and the values of a, b, and c total 100; the molten alloy being under a non-oxidizing atmosphere; and processing the molten alloy by directing a stream of the alloy onto the surface of rotating metal wheel for quenching the stream of molten alloy into particles of alloy composition, the quenching of the stream of molten alloy being controlled to form either
(a) a crystalline material comprising principally the compound Ce₂Fe₁₄B and having permanent magnet properties or (b) amorphous or nanocrystalline particles of the cerium-iron-boron composition from the melt, some particles having properties of a soft magnetic material and susceptible to annealing at a temperature above about 450° C. for a time to form a crystalline material comprising principally the compound Ce₂Fe₁₄B and having permanent magnet properties; the crystalline material resulting from each of (a) or (b) having values of intrinsic coercivity, H_{ci} in kOe, and remanence, Bᵣ in kG, where the numerical sum of H_{ci} and Bᵣ is 8 or greater.

19. A method as recited in claim 18 in which the numerical sum of H_{ci} and Bᵣ is 9 or greater.

20. A method as recited in claim 18 in which the permanent magnet composition produced is selected from the group consisting of Ce_{16.7}Fe_{77.8}B_{5.6}, Ce_{14.3}Fe_{78.6}B_{7.1}, Ce_{15.4}Fe_{76.9}B_{7.7}, Ce_{17.9}Fe_{77.9}B_{4.2}, Ce_{22.8}Fe_{71.1}B_{6.1}, Ce_{14.4}Fe_{74.9}B_{10.7}, Ce_{18.2}Fe_{72.7}B_{9.1}, Ce_{21.1}Fe_{73.7}B_{5.3}, Ce_{13.3}Fe_{80.0}B_{6.7}, Ce_{18.5}Fe_{70.0}B_{11.5}, and Ce_{23.1}Fe_{73.5}B_{3.4}.
